(19) United States
(12) Patent Application Publication
(10) Pub. No.: US 2004/0081589 A1
(43) Pub. Date: Apr. 29, 2004

(54) Elevated temperature combinatorial catalytic reactor

(76) Inventors: Ara J. Alexanian, Des Plaines, IL (US); Johann W. Sachtler, Des Plaines, IL (US); Arne Karlsson, Oslo (NO); Elisabeth M. Myhrvold, Jar (NO); Ivar M. Dahl, Oslo (NO)

Correspondence Address: JOHN G TOLOMEI, PATENT DEPARTMENT, UOP LLC, 25 EAST ALGONQUIN ROAD, P O BOX 5017, DES PLAINES, IL, 60017-5017, US

(21) Appl. No.: 10/232,934

(22) Filed: Aug. 29, 2002

(51) Int. Cl. G01N 31/10

(52) U.S. Cl. 422/102; 422/68.1; 436/37

(57) ABSTRACT

A reactor for conducting catalytic chemical reactions has been developed. The reactor has a housing having an open end and a closed end. The reactor also has a sleeve having a top end and a bottom end. The bottom end of the sleeve is inserted within the open end of the housing. A fluid permeable structure is attached to the sleeve spanning the cross-section thereby defining a chamber between the closed end of the housing and the fluid permeable structure. The reactor also has a reactor insert having a first end and a second end containing a first and a second fluid conduit. The first end of the reactor is inserted within the top end of the sleeve.

### FIELD OF THE INVENTION

The invention relates to a reactor for evaluating catalysts, and particularly to a plurality of reactors for combinatorial chemistry.

### STATEMENT REGARDING FEDERALLY SPONSORED RESEARCH OR DEVELOPMENT

This invention was made under the support of the United States Government, Department of Commerce, National Institute of Standards and Technology (NIST), Advanced Technology Program, Cooperative Agreement Number 70NANB9H3035. The United States Government has certain rights in the invention.

### BACKGROUND OF THE INVENTION

Developments in combinatorial chemistry have largely concentrated on the synthesis of chemical compounds. For example, U.S. Pat. Nos. 5,612,002 and 5,766,556 disclose a method and apparatus for multiple simultaneous synthesis of compounds. WO 97/30784-A1 discloses a microreactor for the synthesis of chemical compounds. Akporiaye, D. E.; Dahl, I. M.; Karlsson, A.; Wendelbo, R. Angew Chem. Int. Ed. 1998, 37, 609-611 disclose a combinatorial approach to the hydrothermal synthesis of zeolites, see also WO 98/36826-A1. Other examples include U.S. Pat. Nos. 5,609,826, 5,792,431, 5,746,982, and 5,785,927, and WO 96/11878-A1.

More recently, combinatorial approaches have been applied to catalyst testing to try to expedite the testing process. For example, WO 97/32208-A1 teaches placing different catalysts in a multicell holder. The reaction occurring in each cell of the holder is measured to determine the activity of the catalysts by observing the heat liberated or absorbed by the respective formulation during the course of the reaction and/or analyzing the products or reactants. Thermal imaging had been used as part of other combinatorial approaches to catalyst testing, see Holzwarth, A.; Schmodt, H.; Maier, W. F. Angew. Chem. Int Ed., 1998, 37, 2644-2647, and Bein, T. Angew. Chem. Int. Ed., 1999, 38, 323-326. Thermal imaging may be a tool to learn some semi-quantitative information regarding the activity of the catalyst, but it provides no indication as to the selectivity of the catalyst.

Some attempts to acquire information as to the reaction products in rapid-throughput catalyst testing are described in Senkam, S. M. Nature, July 1998, 384(23), 350-353, where laser-induced resonance-enhanced multiphoton ionization is used to analyze a gas flow from each of the fixed catalyst sites. Similarly, Cong, P.; Doolen, R. D.; Fan, O.; Giaquinta, D. M.; Guan, S.; McFarland, E. W.; Poojary, D. M.; Self, K.; Turner, H. W.; Weinberg, W. H. Angew Chem. Int. Ed. 1999, 38, 484-488 teaches using a probe with concentric tubing for gas delivery/removal and sampling. Only the fixed bed of catalyst being tested is exposed to the reactant stream, with the excess reactants being removed via vacuum. The single fixed bed of catalyst being tested is heated and the gas mixture directly above the catalyst is sampled and sent to a mass spectrometer.

Combinatorial chemistry has been applied to evaluate the activity of catalysts. Some applications have focused on determining the relative activity of catalysts in a library; see Klien, J.; Lehmann, C. W.; Schmidt, H.; Maier, W. F. Angew Chem. Int. Ed. 1998, 37, 3369-3372; Taylor, S. J.; Morken, J. P. Science, April 1998, 280(10), 267-270; and WO 99/34206-A1. Some applications have broadened the information sought to include the selectivity of catalysts. WO 99/19724-A1 discloses screening for activities and selectivities of catalyst libraries having addressable test sites by contacting potential catalysts at the test sites with reactant streams forming product plumes. The product plumes are screened by passing a radiation beam of an energy level to promote photoions and photoelectrons which are detected by microelectrode collection. WO 98/07026-A1 discloses miniaturized reactors where the reaction mixture is analyzed during the reaction time using spectroscopic analysis. Some commercial processes have operated using multiple parallel reactors where the products of all the reactors are combined into a single product stream; see U.S. Pat. Nos. 5,304,354 and 5,489,726.

In U.S. Pat. Nos. 6,327,344 and 6,342,185, a high efficiency combinatorial reactor is described. The reactor has a well having an open end and a closed end. The reactor also has a sleeve having a top end and a bottom end. The bottom end of the sleeve is inserted within the open end of the well. A fluid permeable structure is attached to the sleeve spanning the cross-section thereby defining a chamber between the closed end of the well and the fluid permeable structure. The reactor also has a reactor insert having a fluid permeable end and a top end containing a first and a second fluid conduit. The fluid permeable end of the reactor is inserted within the open end of the sleeve. The first fluid conduit is in fluid communication with the chamber, and the second fluid conduit is in fluid communication with the fluid permeable end of the reactor insert.

Applicants have developed a reactor particularly suited for use in combinatorial evaluation of catalysts, especially at elevated temperatures. Multiple reactors may be readily assembled in an array for the simultaneous evaluation of a number of catalysts. The housings of the multiple reactors may be supported by a single support, and the reactor inserts of the multiple reactors also may be supported by a single support thereby allowing for easy handling and assembly of an array of multiple reactors. The reactor has particular design features to minimize coking, reduce thermal cracking, and maintain the integrity of the apparatus at elevated temperatures.

### SUMMARY OF THE INVENTION

The invention is a reactor for conducting catalytic chemical reactions. The reactor has a housing having an open end and a closed end and a sleeve having a top end, a bottom end, and a cross-section, the bottom end of the sleeve inserted within the open end of the housing. A fluid permeable structure is attached to the sleeve at least partially spanning the cross-section of the sleeve and partially defining a passage between the closed end of the housing and the fluid permeable structure, where the passage extends from the closed end of the housing through the annular space defined by the interior of the housing and the exterior of the sleeve. A reactor insert having a first end and a second end, is inserted within the top end of the sleeve to define a reaction chamber. The second end of the reactor insert contains a first and a second fluid conduit. The reactor insert further comprises a first portion (see reference number 23 of FIG. 5) defining a volume of no fluid flow which forms the first end and a second portion (see reference number 25 of FIG. 5) adjacent the second end defining a volume for fluid flow from the second fluid conduit to the reaction chamber and defining at least one introduction point of fluid into the reaction chamber. The introduction point is positioned to minimize stagnant fluid in the reaction chamber. The first portion of no fluid flow reduces thermal cracking of hydrocarbons. A first seal engages the reactor insert and the housing and a second seal engages the reactor insert and the sleeve.

In a more specific embodiment of the invention, the reactor insert further comprises a thermowell capable of housing a temperature sensor. The thermowell extends from the second end of the insert, through the second and first portions of the reactor insert, beyond the first end of the insert, and into the reaction chamber. It is preferred that the thermowell extends through a bore in the reactor insert. The thermowell houses a temperature sensor for measuring the temperature in the reaction chamber. The thermowell may be welded to the second portion of the reactor insert. The welds are located at both ends of the second portion of the reactor insert and block any fluid flow in the annular space formed by the external diameter of the thermowell and the bore of the second portion of the reactor insert. The thermowell may also define a hole to equalize the pressure between the thermowell and any gap that may form between the second portion of the reactor insert and the thermowell.

A preferred embodiment of the invention is one where the apparatus is a plurality of individual reactors, each reactor as described above. Another preferred embodiment of the invention is one where a plurality of housings are attached to a single support, and the corresponding plurality of reactor inserts are attached to a second single support. An alternative embodiment is one where a fluid conduit is in fluid communication with the closed end of the housing.

### BRIEF DESCRIPTION OF THE DRAWINGS

FIG. 1 is an exploded sectional side view of a preferred reactor.

FIG. 2 is an assembled sectional side view of the same preferred reactor of FIG. 1.

FIG. 3 is an end view of the sleeve.

FIG. 4 is an end view of a section of the reactor insert taken along section line A-A.

FIG. 5 in an enlarged view of the reactor insert of a preferred reactor.

FIG. 6 is an assembled sectional side view of an alternative embodiment of the reactor where the closed end of the housing contains a conduit for fluid flow.

### DETAILED DESCRIPTION OF THE INVENTION

In general terms, the invention is a reactor for use in combinatorial applications and a process for conducting a combinatorial catalyzed reaction. The particular design the reactor is especially beneficial in application where the reaction is conducted at elevated temperatures. In combinatorial applications, the reactor of the present invention is used as an array of multiple reactors operating simultaneously in parallel. Preferably the reactor consists of three main components, (I) a reactor insert, (II) a sleeve, and (III) a housing. Each of the main components may be constructed out of materials suitable to the application contemplated. The materials chosen are selected to withstand the temperatures, pressures and chemical compounds of the particular application. Examples of suitable materials include metals and their alloys, low grade steel, and stainless steels such as Austenitic steels, superalloys like incoloy, inconel, hastelloy, engineering plastics and high temperature plastics, ceramics such as silicon carbide and silicon nitride, glass, and quartz. Although preferred, it is not necessary that each component be made of the same material.

The housing is preferably cylindrical in shape, but may be of other geometric shapes. For example, the cross-section of the housing may be in the shape of a square, an ellipse, a rectangle, a polygon, “D”-shaped, segment-, or pie-shaped, lens-shaped, defined by a chord and a curve, or the like. For ease of discussion, the housing is discussed here as having a cylindrical shape. The housing has a top end, sides, and a bottom end. The top end is open and the bottom end is closed. It is possible to design the reactor of the present invention at sizes such that the volume of the housing may be from about one to about one-hundred liters, or even more, but the greatest benefit has been found when the reactor of the present invention is designed on a smaller scale. The preferred volume of the housing ranges from about 0.001 cm³ to about 1000 cm³ with the most preferred volumes ranging from about 0.1 cm³ and 25 cm³. Examples of the size of the housing ranges from a length/diameter ratio of about 3 to about 320, and preferably from about 10 to about 96. It is more preferred that the length/diameter of the housings be greater than about 15 and ideally about 30. The size of the housings, and particularly, the length of the housings as described above are merely guidelines and the actual size of the housings are mainly determined by the temperature of operation and the seals. The guidelines may be greatly altered by including a cooling system near to the top of the reactor so that the seals are maintained at a suitable temperature. The cooling system may be as simple as a plate or a fin, or may be more complex such as an air cooler or a liquid cooler. The goal of the cooler is to cool the reactor in the vicinity of the seals so that the seals do not fail.

It is preferred that the housing be constructed of material that is able to withstand temperatures of from about 10° C. to about 1000° C. It is also preferred that the housing be constructed of material having good heat transfer properties and that the material of construction is inert in the reaction being conducted in the reactor. Depending upon the application, the metals of the housing, and other elements of the invention discussed below, may be passivated using commonly known techniques. Successful passivation techniques include those such as, hydrogen sulfide passivation, tin coating of the metal, alanizing the metal, ceramic coating of the metal, quartz coating of the metal, and the like.

The housing may be a freestanding unit, or multiple housings may be formed from a single tray or block of material. It is preferred to have a single tray, rack, or support to which multiple housings are attached. For example, a single unit such as a tray, rack, or block of material may support 6, 8, 12, 24, 48, 96, 382 or 1264 housings. A heater having wells in which housings may be inserted may perform the function of the rack. It is most preferred that the single unit be similar to the dimensions of a commonly used microtiter tray. A larger format may be easier to machine, but the smaller microtiter tray format is a compatible size with available equipment that may be used in conjunction with at least part of the reactor of the present invention. The microtiter tray format, if selected, may be a factor in determining the sizing and diameter of the reactors. The multiplicity of housings may be heated as a unit, or each housing may be individually heated. It is preferred that the heater be positioned adjacent to the housings near the reaction chamber. It is preferred that the open end of the housing contain a flange. The flange of the open end of the housing and the flange of the reactor insert may be used to apply pressure to keep the reactor sealed (discussed below). Optionally, the housing may contain a projection extending from the side of the housing partially into the interior of the housing to properly position and retain the sleeve (discussed below) within the housing. The projection is located at the closed end of the housing, at a location where the bottom end of the sleeve (discussed below) rests on the projection. In a more preferred embodiment, the projection is located at the open end of the housing where the top end of the sleeve is flared to engage the projection of the housing. The projection may be any of various possibilities of support such as a ledge, lip, or a shelf extending from the side of the housing into the interior of the housing.

A sleeve is inserted into the housing and a reactor insert is inserted into the sleeve resulting in a nested three-component configuration. In the assembled reactor, the sleeve is positioned between the reactor insert and the housing. As with the housing, the sleeve is preferably cylindrical in shape, but may be of other geometric shapes. For example, the general cross-section of the sleeve may be in the shape of a square, an ellipse, a rectangle, a polygon, “D”-shaped, segment- or pie-shaped, cog- or gear-shaped, lens-shaped, defined by a chord and a curve, or the like. It is preferred that the geometry of the sleeve is chosen to coordinate with the geometry of the housing. It is most preferred that the sleeve is cylindrical, and for ease of discussion, the sleeve is discussed here as having an overall cylindrical shape.

The sleeve has a top end, sides, and a bottom end. The top and bottom ends of the sleeve are open. A microporous containment device, which may be constructed of any material that is capable of retaining solid particles while allowing gas or liquid to pass through, is attached at or near the bottom end of the sleeve and extends across the cross-section, or internal diameter, of the sleeve. Examples include frits, membranes, fine meshed screens, or fibrous materials. Suitable frits include sintered metal, quartz, sintered quartz, and raney metals. Suitable membranes include electro-bonded films and etched alloy films. A suitable fibrous material is a quartz wool. Frits are preferred for the microporous containment device at or near the bottom of the sleeve, and it is preferred that the frit cover as much of the cross-section of sleeve as possible, and most preferred that the frit cover as close to 100 percent of the cross-section of the sleeve as practical. It is most preferred to have a frit with small passages so that the fluid is well dispersed after passing through the frit, but not so small as to cause a high pressure drop. The interior volume of space defined by the top of the sleeve, sides of the sleeve, and the microporous containment device attached to the sleeve along with the reactor insert and a seal (described below) is a reaction chamber. Catalyst particles are placed in a reaction zone of the reaction chamber. It is not expected that the entire reaction chamber contain catalyst particles, and hence the portion of the reaction chamber that contains the catalyst particles will be termed the reaction zone.

The external diameter of the sleeve is less than the internal diameter of the housing so that the sleeve may be inserted into the housing. In one embodiment of the invention, the length of the sleeve may be less than the length of the housing so that a chamber is formed between the bottom end of the sleeve and the bottom end of the housing. It is preferred that the length of the sleeve be from about 70% to about 99.9% of the length of the housing. In a less preferred embodiment of the invention, the sleeve extends the entire length of the housing with the bottom end of the sleeve resting on the bottom of the housing. In this embodiment, the microporous containment device is located near but not at the bottom end of the sleeve. Furthermore, in this embodiment, the sides of the sleeve at the bottom end of the sleeve have portions removed so that as the bottom end of the sleeve rests on the bottom end of housing, channels are formed through which fluid is able to flow. For example, the bottom end of the sleeve may have ridges, or may be scalloped or grooved.

It is preferred that the sleeve is constructed of material that is able to withstand temperatures of from about 10° C. to about 1000° C. and it is preferred that the sleeve be constructed of the same material as the housing. It is also preferred that the sleeve be constructed of material having good heat transfer properties. Metals passivation as discussed above may be applied to the sleeve as well as the housing.

The sleeve and the housing are sized so that with the sleeve inserted into the housing, the external surface of the sleeve and the internal surface of the housing form an annular passage through which a fluid is able to flow. For example, the fluid may flow from the interior of the sleeve, through the fluid permeable structure attached to the sleeve, then through the annular space between the external surface of the sleeve and the internal surface of the housing, to be removed from the reactor.

In one embodiment of the invention, the sleeve contains two portions of different external diameters. Near to the top end, the sleeve may have a larger external diameter, D1, portion. Near to the bottom end, the sleeve may have a smaller external diameter, D2, portion. The external diameter D1 is greater than the external diameter D2. The inside diameter of the sleeve may remain constant with only the external diameter changing between the two portions. In applications using elevated temperatures, coke formation may become a problem. Contact points or near-contact points between the sleeve and the housing in the vicinity of the elevated temperature may generate excessive coke and cause the sleeve and the housing to become lodged together thereby preventing the separation of the sleeve from the housing. Coke formation may also result in damage to or deformation of the housing or the sleeve. To prevent or minimize coke formation, the distance between the sleeve and the housing in the vicinity of the high temperature is increased, hence the smaller external diameter of the sleeve near to the bottom end. In other words, that portion of the sleeve that will be in the area of the reactor where coke formation is expected to occur, may have a smaller diameter so that the distance between the external diameter of the sleeve and the internal diameter of the housing is increased. The increased distance helps to minimize coke formation. However, it may be desired to have a larger external diameter of the sleeve to aid in the alignment of the sleeve within the housing during assembly of the reactor and during use. The portion of the sleeve with the larger external diameter is located at the top end of the sleeve. The temperature at the top end the sleeve is expected to be lower than at the bottom end of the sleeve and therefore the coke formation is expected to be less of a problem at the top end of the sleeve. Thus, the alignment advantage of a larger external diameter at the top end of the sleeve would be preserved without unduly risking the sleeve and the housing becoming lodged together or damaged due to coke formation. The benefit of assisted alignment should be weighed against the likelihood of coke formation. In one embodiment of the invention, most of the sleeve extending upward from the bottom end has the smaller external diameter from about 5 to about 70 percent of the overall length of the sleeve having the larger external diameter. The above range is only a guideline, the amount of the sleeve having the smaller external diameter is determined through estimating the point at which the temperature of the sleeve will be low enough so that coke formation is not a problem.

Although not necessary, it is preferred that either the top end of the sleeve with the larger external diameter or the internal surface of the housing, or both, define grooves that upon insertion of the sleeve into the housing form the channels for the passage of fluid between the sleeve and the housing. The grooves may run parallel to the length of the sleeve, may follow the circumference of the sleeve in a spiral pattern, or may form a wave pattern. The channels formed by the grooves provide a path for fluid to flow along the external surface of the sleeve. The pattern chosen for the grooves may vary and include forming channels that run parallel to the length of the sleeve or that spiral around the circumference of the sleeve.

In another embodiment, the sleeve has a constant external diameter. In this embodiment, the external surface of the sleeve does not contact the internal surface of the housing, except at the flared top of the sleeve (discussed below or perhaps if the bottom of the sleeve were to rest on the internal bottom of the housing), and that a sufficient gap between the housing and the sleeve be provided, not only for the passage of fluid, but also to minimize or eliminate coke formation. If the external diameter of the sleeve is too close to the internal diameter of the housing, coke formation may be increased and the two components may become lodged together through coke build-up thereby defeating the ease of operation afforded by having a removable sleeve. Coke formation may also lead to damage of the housing, the sleeve and/or the reactor insert. With the increased distance between the interior of the housing and the exterior of the sleeve in this embodiment, neither the sleeve nor the housing has grooves for fluid passage. An advantage with this embodiment of the invention is a significantly reduced cost in machining the sleeve and the housing.

The sleeve preferably is flared at the top end. The flared portion of the top end also preferably defines notches. The amount of flare at the top end of the sleeve should be sufficient so that the flare engages a projection near the open end of the housing thereby suspending the sleeve within the housing. The portion of the sleeve attached to the fluid permeable microstructure is suspended at a location adjacent to the heating element so that the catalyst contained within the reaction chamber of the invention is in a heated reaction zone. The notches allow for the fluid flow between the exterior of the sleeve and the interior of the housing to pass through the location where the flange of the sleeve engages the projection of the housing.

A reactor insert is inserted into the sleeve. The reactor insert also has a first end, sides, and a second end. As with the housing and the sleeve, the reactor insert is preferably cylindrical in shape, but may be of other geometric shapes such as a cross-section in the shape of a square, an ellipse, a rectangle, a polygon, “D”-shaped, segment- or pie-shaped, cog- or gear-shaped, lens-shaped, defined by a chord and a curve, or the like. However, with the reactor insert, it is preferable to have the geometry of the reactor insert conform to the geometry of the interior of the sleeve. For ease of discussion, the reactor insert is discussed here as having a preferred cylindrical shape. It is preferred that the reactor insert be constructed of material that is able to withstand temperatures of from about 10° C. to about 1000° C. and it is preferred to construct the reactor insert from the same material as the housing and the sleeve.

The external diameter of the reactor insert is less than the internal diameter of the sleeve so that the reactor insert may be inserted into the sleeve. The length of the reactor insert is less than the length of the sleeve measured from the top end of the sleeve to the fluid permeable structure attached to the sleeve, so that a reaction chamber is formed between the reactor insert, the sleeve with the fluid permeable structure attached to the sleeve and a seal. Solid catalyst particles are retained within a reaction zone which is a part of the reaction chamber. It is preferred that the length of the reactor insert be from about 5% to about 99% of the length of the sleeve measured from the top end of the sleeve to the fluid permeable structure attached to the sleeve, and most preferred that the length of the reactor insert be from about 50% to about 99% of the length of the sleeve measured from the top end of the sleeve to the fluid permeable structure attached to the sleeve. The first end of the reactor insert is inserted into the sleeve so the reactor insert is nested within the sleeve. In the nested configuration, the first end of the reactor insert is proximate the bottom of the sleeve and the fluid permeable structure attached to the sleeve, and the second end of the reactor insert is proximate the top of the sleeve.

The reactor insert preferably retains two seals, preferably o-rings. One seal operates to form a pressure-tight seal between the housing and the reactor insert, and the other seal operates to form a pressure-tight seal between the reactor insert and the sleeve. Alternate pressure seals may be employed such as VCR, compression fittings, flanged fittings, or hoffer fittings, but o-rings are preferred. It is not required that the reactor insert retain the seals, but such a configuration is preferred for ease of use. It is preferred that the second end of the reactor insert contain a flange. The flange would be used along with the flange in the housing for ease of maintaining the assembly in the proper sealed configuration during operation. Pressure could be easily asserted against the flanges to maintain the seals. It is most preferred that the seals be an o-rings, which may be made of, for example, Viton, Teflon, Kalrez, or Isolast. When operating at very high temperatures, a preferred seal may be an Isolast o-ring, which is reliable up to temperatures of about 350° C. It is preferred to use the most economical seal that provides a suitable sealing function at the particular temperatures the seals will be exposed to during operation of the reactor.

The reactor insert contains at least two portions. A first portion defines a volume of no fluid flow through the reactor insert which forms the first end of the reactor insert. Adjacent the second end of the reactor insert is a second portion of the reactor insert which defines a volume for fluid flow from a fluid conduit of the second end of the reactor insert to the reaction chamber. The second portion of the reactor insert also defines at least one fluid introduction point for fluid to be introduced into the reaction chamber. It is preferred to have at least two or three, and most preferred to have at least four fluid introduction points to the reaction chamber defined by the second portion of the reactor insert. The second portion of the reactor insert is located adjacent the second end of the reactor insert for very specific reasons, the most important of which is to control the amount of coke formation within the reaction chamber. One goal of the design of the present invention is to minimize stagnant fluid flow within the apparatus thereby reducing coke formation. Though placing the fluid introduction points of the reaction chamber near to the second end of the reactor insert, fluid within the reaction chamber is maintained flowing and little fluid flow becomes stagnant. The annular space of the reaction chamber that is created around the exterior of the reactor insert is swept with fluid flow from the fluid introduction points and has reduced opportunities within the reaction chamber to become trapped and form an area of stagnant fluid. The opportunity for coke formation is thereby reduced.

Because the fluid introduction points are near to the second end of the reactor insert, and the catalyst particles are near to the bottom of the sleeve, it is not necessary to insert a fluid permeable structure within the fluid introduction points of the second portion of the reactor insert. However, in some applications it may be desirable. Therefore a fluid permeable structure, such as a material capable of excluding solid particles while allowing gas or liquid to pass through may be inserted within or attached to the fluid introduction points. Examples include frits or membranes as discussed above for the sleeve. Catalyst particles are unable to pass through the permeable structure and are therefore retained within the reaction chamber.

As discussed above, the first portion of the reactor insert defines a volume of no fluid flow which forms the first end of the reactor insert. It is preferred that the first portion of the reactor insert is a solid unit that extends from the second portion of the reactor insert into the reaction chamber. The purpose of the first end of the reactor insert is to reduce the volume of the reaction chamber and thereby reduce the thermal residence time of the fluid in the reaction chamber. The goal of reducing the thermal residence time of the fluid in the reaction chamber is to control the amount of cracking of components within the fluid. With less volume in the reaction chamber the fluids will pass through the chamber in less time and less cracking should occur.

In a preferred embodiment, the point at which the first and second portion meet is defined through a blockage, such as welding, of the volume through which the fluid passes. As stated above, the second portion of the reactor insert defines a volume for fluid flow. For ease of manufacture, the first portion of the reactor insert may also contain a volume through which fluid may have been able to flow, but that is blocked to prevent the flow of fluid. In this embodiment, it is the location of the blockage that defines where the first and second portions meet.

It is preferred that the reactor insert also have a thermowell, or guide tube, capable of housing a temperature sensor such as a thermocouple, a thermistor, or a temperature sensitive resistor which is also known as a resistance temperature detector (RTD). A preferred temperature sensor is a thermocouple. The temperature sensor is used for monitoring the temperature of the reaction zone. The thermowell extends from the second end of the reactor insert, through the second and first portions of the reactor insert, beyond the first end of the reactor insert and into the reaction chamber, and specifically into the reaction zone of the reaction chamber. The thermowell usually has a closed end and an open end. The closed end may be formed by, for example, laser welding. It is the closed end that extends into the reaction zone. The closed end can be above the catalyst particles or immersed into the catalyst particles. It is preferred that the closed end of the thermowell be positioned above the catalyst particles so the temperature sensor is measuring the temperature of the reaction zone and is not unduly affected by the endothermic or exothermic nature of the reaction.

Generally, the thermowell is open to the atmosphere, or only lightly sealed to allow for easy insertion or withdrawal of a temperature sensor. In the preferred embodiment where the first portion of the reactor insert is a solid unit, the first portion may define a through-going bore. The thermowell is inserted through this through-going bore. It is preferred that the thermowell be attached to the second portion of the reactor insert at both ends of the second portion of the reactor insert using laser welds, although other types of welds, such as TIG welds or micro-TIG welds may also be successful. The laser welds are precise welds formed using a laser that continuously attaches the thermowell to the first portion of the reactor insert preferably at each end of the first portion of the reactor insert. The welds are not spot welds, but are continuous and placed so as to block fluid flow through the bore of the second portion of the reactor insert. For example, the laser weld may span the circumference of the cross sectional area of the bore at each end of the second portion of the reactor insert.

However, a gap may be present between the internal surface of the through-going bore of the first portion of the reactor insert and the external surface of the thermowell. Because the thermowell is laser welded to the first portion of the reactor insert at each end of the through-going bore, air may be trapped within this gap. When the assembled reactor is placed into use and heated, pressure may build in the gap due to the trapped air being heated and mechanical problems may arise. Therefore, it is preferable for the thermowell to define a hole that allows fluid communication between the gap and the interior of the thermowell. As the assembled reactor is heated, air may pass from the gap through the hole in the thermowell and into the interior of the thermowell thereby preventing the build up of pressure in the gap. Although less preferred, it is further within the scope of the invention to attach a temperature sensing device directly to the reactor insert, without the presence of a thermowell.

As with the sleeve, one embodiment of the reactor involves the reactor insert containing two portions of different external diameters. Near to the second end, it is preferred to have a larger external diameter, D3, section. Near to the first end, it is preferred to have a smaller external diameter, D4, section. The external diameter D3 is greater than the external diameter D4. The inside diameter of the second portion of the reactor insert may remain constant with only the external diameter changing between the two sections. As discussed above, in applications using elevated temperature, carbon formation may become a problem. Insufficient distance and contact points between the reactor insert and the sleeve in the vicinity of high temperatures may generate excessive coke and cause the reactor insert and the sleeve to become lodged together thereby preventing the separation of the reactor insert from the sleeve. Damage or deformation of the parts of the reactor may result. To prevent or minimize coke formation, the distance between the external diameter of the reactor insert and the internal diameter of the sleeve in the vicinity of the high temperature is increased, hence the smaller external diameter of the reactor insert near to the first end. In a preferred embodiment, most of the reactor insert extending upward from the first end has the smaller external diameter with only a from about 5 to about 90 percent of the overall length of the reactor insert having the larger external diameter. The portion of the reactor insert with the larger external diameter is located at the second end of the reactor insert. The temperature at the second end of the reactor insert is expected to be lower than at the first end of the reactor insert and therefore the coke formation is expected to be less of a problem at the second end of the reactor insert. It is therefore less likely that the larger external diameter at the second end of the reactor insert would cause the reactor insert and the sleeve to become lodged together or damaged due to coke formation.

Although not necessary, it is preferred that the section of the reactor insert having the larger diameter have grooves formed in the external surface so that a portion of the insert remains in contact with the internal surface of the sleeve. This contact is helpful in aligning the insert within the sleeve, and maintaining that alignment during use. The pattern chosen for the grooves may vary depending upon the degree of preheating needed for the reactant and the particular reaction involved. For example, grooves and therefore channels that run parallel to the length of the sleeve would provide less residence time of the fluid within the channels and less preheating. On the other hand, grooves and channels that spiral around the circumference of the sleeve provide greater residence time of the fluid within the channels and greater preheating, but may allow time for background reactions to occur.

Alternatively, the reactor insert may have a constant external diameter. In this embodiment, it is preferred that the external surface of the reactor insert does not contact the internal surface of the sleeve, and that a sufficient gap between the insert and the sleeve be provided, not only for the passage of fluid, but also to minimize coke formation. If the external diameter of the insert is too close to the internal diameter of the sleeve, coke formation may be increased and the two components may become fused thereby defeating the ease of operation afforded by having a removable insert and sleeve. With the increased distance between the interior of the sleeve and the exterior of the insert in this embodiment, it is preferred that neither the insert nor the sleeve have grooves for fluid passage.

As discussed above, one fluid conduit is located at the second end of the reactor insert. A second fluid conduit may be positioned in a variety of locations to allow fluid to pass to or exit from the annular space or the channels formed by the sleeve and the housing. A preferred location for the second fluid conduit is at the second end of the reactor insert in fluid communication with a volume of space defined by the reactor insert and the housing and an o-ring seal-engaging the reactor insert and the housing. Alternatively, the second fluid conduit may pass through the side of the housing and provide a passage for fluid to flow into or out of the channels formed by the sleeve and the housing. It is preferred that the second fluid conduit pass through the second end of the reactor insert to the volume of space between the flange of the reactor insert and the flange of the housing so that all fluid conduits are a part of the reactor insert. In a specific embodiment of the invention either the first or the second fluid conduit is in fluid communication with a reactant reservoir. Similarly, the fluid conduit that is not in fluid communication with a reactant reservoir may be in fluid communication with a sampling device that is used to sample the effluent exiting the reactor.

Since the present reactor is particularly beneficial for conducting reactions at temperatures in the range of about 450° C. to about 700° C. or higher, such as 800° C. or 900° C., it is preferred that the length of the reactor be greater than that of similar reactors used in lower temperature reactions. The seals used to engage the insert and the sleeve and the insert and the housing are generally reliable up to temperatures from about 160° C. to about 325° C., with Isolast and Kalrez being reliable at the higher end of the range. Since the reaction temperatures are likely to exceed the recommended limits of the seals, the present invention uses the length of the reactor to control the temperature of the reactor near the seals and to maintain the temperature of the seals within their operating range. The heating element is generally located near the reaction chamber which contains the catalyst. Therefore, the portion of the reactor above the reaction chamber may be elongated to allow for dissipation of the heat from the heating element. Both the thermal conductance of the material used to form the reactor as well as the temperature used in the reaction are factors determining the optimal length of the reactor. The lower the thermal conductance of the material forming the reactor and the lower the temperature of operation, the shorter the length of the reactor. One example of a suitable design is where the reactor is formed from 321 stainless steel and the operating temperature ranges up to at least 700° C., the assembled reactor as measured from the top of the reactor insert to the closed end of the housing could range from about 8 cm to about 25 cm.

In combinatorial applications, an array of reactors are used in parallel to conduct multiple reactions simultaneously. The preferred reactor described above is successfully used in combinatorial applications. It is preferred that the multiple housings of a number of reactors are attached to a single support such as a rack or tray. The multiple reactor inserts are also preferably attached to a single support such as a top plate, rack, or tray. For combinatorial applications, a single top plate is engaged with a single rack containing multiple housings to form a multiple of individual reactors. It is preferred to have the sleeves be individually movable however. The reactor sleeves may be used in the synthesis of different catalysts, and the sleeves, still containing the catalysts, are inserted into the housings as described above. The advantage would be the elimination of a catalyst transfer step since the catalyst would remain in the sleeve from the time of synthesis through the testing process. It is preferred to have the same reactant reservoir in fluid communication with each of the multiple reactors.

When in use, the reactors contain at least one catalyst in the reaction chamber to be contacted with the fluid. One of the fluid conduits in each of the reactors may be in fluid communication with the same or different reactant reservoirs, or another source of fluid. The fluid from the reservoir(s) is conducted through the second portion of the reactor insert and into the reaction chamber. Within the reaction chamber, the fluid contacts the catalyst in a reaction zone. Effluent is generated and withdrawn from the reaction chamber by flowing the effluent through the fluid permeable structure attached in the sleeve, through the passage formed by the housing, the sleeve and the first and second seals, and through the second conduit. The effluents may be sampled periodically over time and the effluents may be simultaneously sampled. The effluents may be analyzed using any known analytical technique. Particularly useful techniques include chromatography, spectroscopy, nuclear magnetic resonance, and combinations thereof. From the results of the analyses of the effluent, a variable such as activity, selectivity, yield, ratios of components, approach to equilibrium, figure of merit, octane number of effluent, or combinations thereof. The catalysts in the different reactors may be compared on the basis of any of these variables.

In an alternative embodiment, the fluid flow may be reversed from that described above. Again, the reactors contain at least one catalyst in the reaction chamber to be contacted with the fluid and one of the fluid conduits in each of the reactors may be in fluid communication with the same or different reactant reservoirs. However, in this embodiment, the fluid flows from the reservoir, or other source, through the passage formed by the housing, the sleeve and the first and second seals, and through the fluid permeable structure attached to the sleeve, thus entering the reaction chamber. In the reaction chamber, the fluid contacts the catalyst and effluent is generated within a reaction zone. The effluent is carried with the fluid flow into the second portion of the reactor insert and removed from the reactor via another conduit. In this embodiment, it is preferred to have a fluid permeable structure at the point of fluid communication between the reaction chamber and the second portion of the reactor insert in order to retain catalyst particles within the reaction chamber. This embodiment is particularly useful when the reactor is to be operated in a fluidized bed mode.

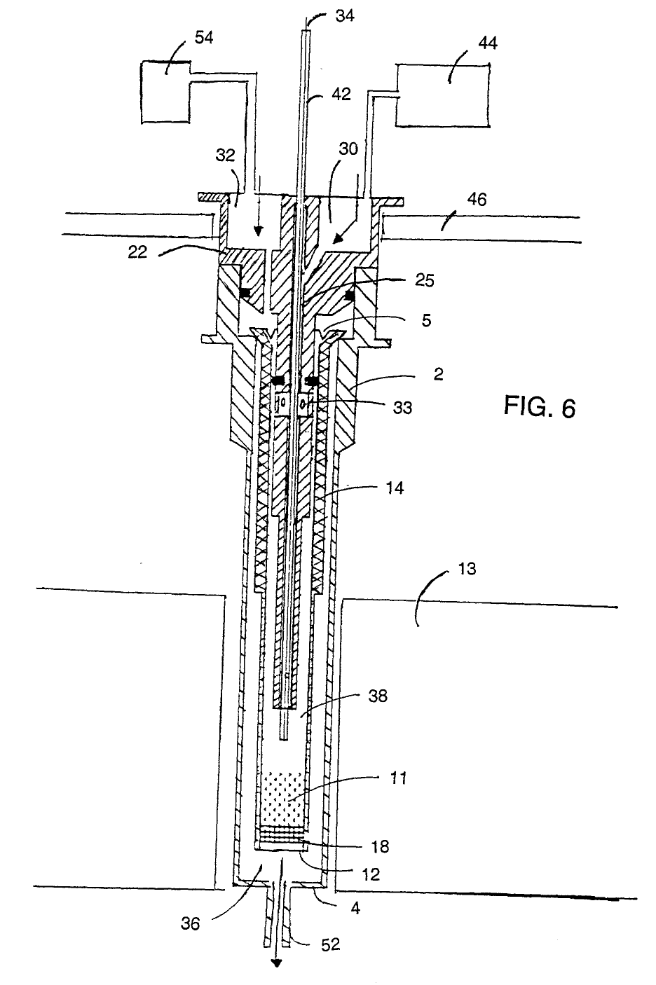

In yet another alternative embodiment, the closed end of the housing may further define or be attached to a conduit to remove fluid from the reactor. In this embodiment, reactant is flowed through the conduit in the reactor insert that is in fluid communication with the reaction chamber and diluent or carrier fluid is flowed through the second conduit of the reactor insert that is in fluid communication with the annular space between interior of the housing and the exterior of the sleeve. Effluent from the reaction chamber and the diluent or carrier fluid is mixed after the effluent is passed through the fluid permeable structure attached to the sleeve. The fluid mixture of effluent and diluent or carrier fluid is removed from the reactor through the conduit at the closed end of the housing. This embodiment is shown in FIG. 6, which is described below.

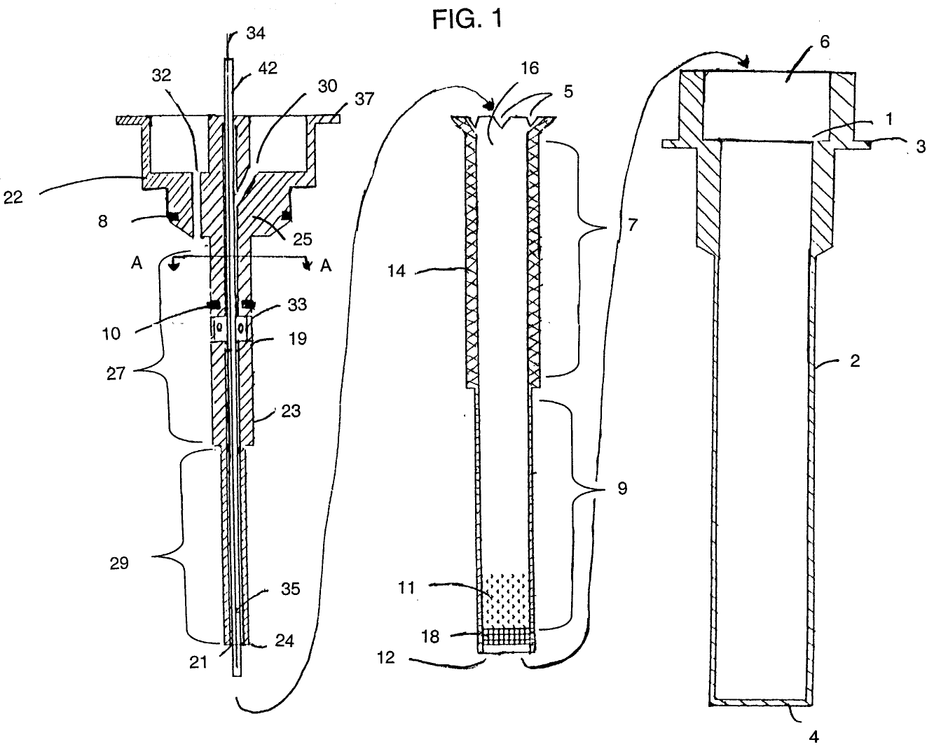

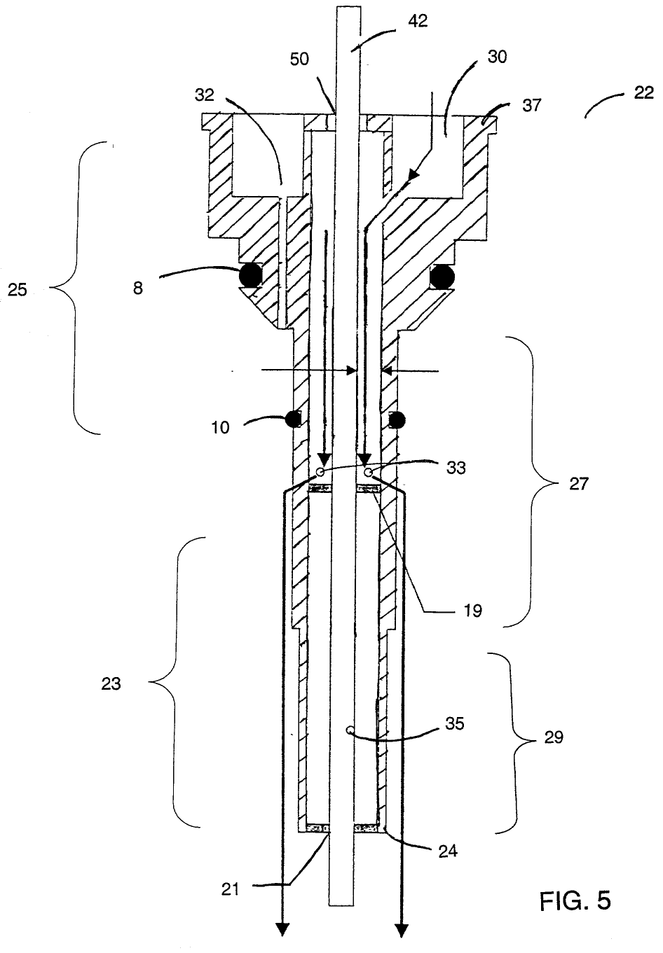

Referring to FIG. 1, an exploded side view of the assembled reactor of the invention, housing 2, has a closed end 4 and an open end 6. Housing 2 preferably has shelf 1 and flange 3. Sleeve 14 has top end 16 and bottom end 12. Top end 16 is preferably flared and defines notches 5. Near the bottom end 12 is frit 18. Catalyst particles 11 are retained by sleeve 14 and frit 18. Sleeve 14 may have a upper portion 7 and a lower portion 9 where the upper portion 7 has a larger external diameter than the lower portion 9. The walls of sleeve 14 in the upper portion 7 having the larger external diameter have material removed to form grooves 20 as shown in FIG. 3, an end view of sleeve 14. Reactor insert 22 has second section 25 in fluid communication with fluid conduit 30 and first section 23. Laser welds 19 and 21 prevent fluid flow through first section 23 of reactor insert 22. Reactor insert 22 optionally may have a larger diameter section 27 and a smaller diameter section 29. The larger diameter section 27 may define grooves 31 that form fluid passages as shown in FIG. 4, an end view of reactor insert 22 taken from section line A-A. Reactor insert 22 further contains fluid introduction points 33, flange 37, and defines conduit 32. Reactor insert 22 is sealed with housing 2 by o-ring 8 and sleeve 14 by o-ring 10 to form pressure tight seals. Thermocouple 34 extends through thermowell 42 which in turn extends through reactor insert 22 and beyond first end 24 of reactor insert 22. Thermowell defines weep hole 35. FIG. 5 provides an enlarged view of reactor insert 22. The enlarged view more clearly shows the details of reactor insert 22, and additionally shows solder 50 which affixes thermowell 42 in reactor insert 22.

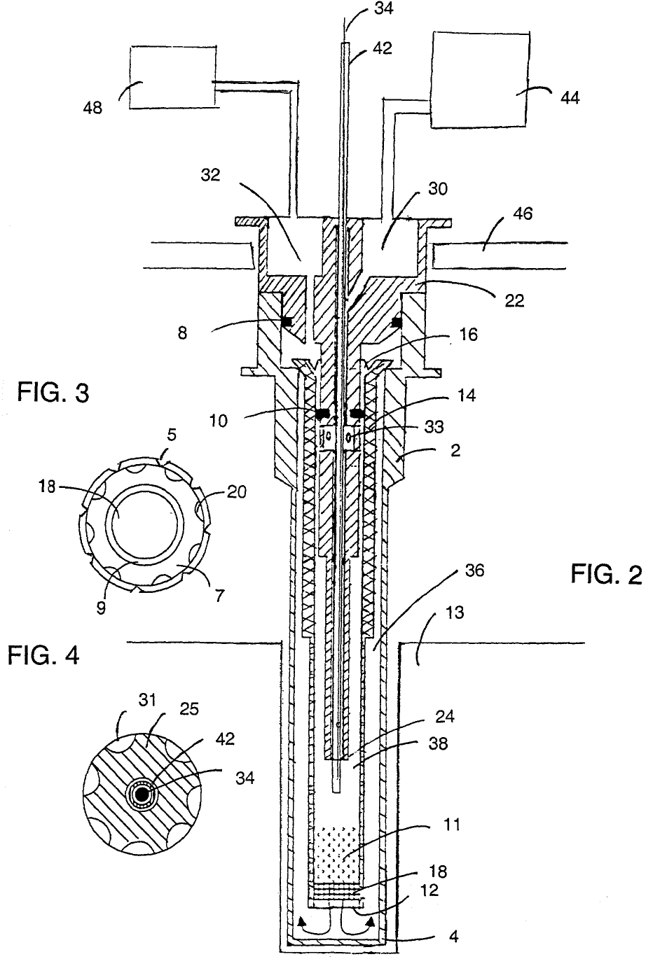

Referring now to FIG. 2, first end 24 of reactor insert 22 is inserted into open end 16 of sleeve 14. O-ring 10 engages both reactor insert 22 and sleeve 16 to form a pressure tight seal. A reaction chamber 38 is formed between o-ring 10, reactor insert 22, and sleeve 14 including the frit 18. Catalyst 11 is retained in reaction chamber 38. Note that reaction chamber 38 need not be completely filled with catalyst 11, and it is preferable that catalyst 11 be located within a reaction zone that is merely part of reaction chamber 38. Fluid introduction points 33 of reactor insert 22 are located at the top of reaction chamber 38. Bottom end 12 of sleeve 14 is inserted into open end 6 of housing 2. Top end 16 of sleeve 14 is flared and rests on ledge 1 of housing 2. Notches 5 of top end 16 allow for fluid to pass between top end 16 and ledge 1. Fluid passage 36 is formed by closed end 4 of housing 2, sleeve 14 having frit 18, and o-ring 8.

Fluid from reservoir 44 enters the assembled reactor via conduit 30 and flows through the second section 25 of reactor insert 22. Fluid exits the second section 25 of reactor insert 22 through introduction points 33 and flows through grooves 31 formed by reactor insert 22 and sleeve 14 into reaction chamber 38 which contains catalyst particles 11. Reaction chamber 38 is adjacent heater 13 which heats the fluid and catalyst in reaction chamber 38 to the appropriate temperature. Thermocouple 34 in thermowell 42 is used to accurately measure the temperature of reaction chamber 38. Effluent is generated and passes through frit 18 and into passage 36 defined by sleeve 14 and housing 2. The effluent passes through notches 5 and exits the reactor insert through conduit 32 to sampling device 48.

FIG. 6 shows the alternative embodiment where the closed end 4 of housing 2 further defines conduit 52. In this embodiment, fluid from reservoir 44 enters the assembled reactor via conduit 30 and flows through the second section 25 of reactor insert 22. Fluid exits the second section 25 of reactor insert 22 through introduction points 33 and flows through grooves formed by reactor insert 22 and sleeve 14 into reaction chamber 38 which contains catalyst particles 11. Reaction chamber 38 is adjacent heater 13 which heats the fluid and catalyst in reaction chamber 38 to the appropriate temperature. Thermocouple 34 in thermowell 42 is used to accurately measure the temperature of reaction chamber 38. Effluent is generated and passes through frit 18 and into passage 36 defined by sleeve 14 and housing 2. At the same time, diluent fluid from reservoir 54 enters the reactor via conduit 32 and passes through notches 5 into the annular space between the interior of housing 2 and the exterior of sleeve 14 flowing to passage 36. Upon contact, the effluent from reaction chamber 38 and the diluent gas mix and the mixture is removed from the reactor via conduit 52. The mixture may be passed to, for example, a storage device or a sampling device. One main advantage of this embodiment of the invention is that products are readily diluted while still in a heated environment before being flowed to, for example, an analysis device.

What is claimed is:

1. An apparatus for conducting a catalyst evaluation comprising:
a) a housing having an open end and a closed end;
b) a sleeve having a top end, a bottom end, and a cross-section, said bottom end inserted within said open end of the housing;
c) a fluid permeable structure attached to said sleeve at least partially spanning the cross-section of said sleeve;
d) a reactor insert having a first end and a second end, said first end inserted within said top end of said sleeve defining a reaction chamber between the sleeve and the reactor insert, said second end containing at least one fluid conduit, the reactor insert further comprising a first portion defining a volume of no fluid flow which forms said first end and a second portion at said second end defining a volume for fluid flow from the fluid conduit to the reaction chamber and defining at least one introduction point of fluid into the reaction chamber where the introduction point is positioned near to a first seal engaging the reactor insert and the sleeve to minimize stagnant fluid in the reaction chamber; and
e) a second seal engaging the reactor insert and the housing.

2. The apparatus of claim 1 further comprising a heat source positioned adjacent to the reaction chamber and the bottom end of the sleeve.

3. The apparatus of claim 2 wherein the length of the housing, the sleeve, and the first portion of the reactor insert are sufficiently long so that the seals are maintained at a temperature within the operable range for the seals.

4. The apparatus of claim 1 wherein the second end of the reactor insert further comprises an additional fluid conduit.

5. The apparatus of claim 1 wherein the reactor insert further comprises a thermowell capable of housing a temperature sensor said thermowell extending from the second end of the insert, through the second and first portions of the reactor insert, and beyond the first end of the insert.

6. The apparatus of claim 5 further comprising a temperature sensor housed within the thermowell.

7. The apparatus of claim 5 wherein the first portion of reactor insert defines a bore and laser welds attach the thermowell to the first portion of the reactor insert blocking fluid flow through the bore in the first portion of the reactor insert.

8. The apparatus of claim 7 wherein the thermowell defines a weep hole located in the first portion of the reactor insert providing fluid communication between the thermowell and the bore.

9. The apparatus of claim 1 wherein said housing has an inner diameter which is sufficiently larger than an outer diameter of said sleeve, and said sleeve has a inner diameter sufficiently larger than an outer diameter of said first portion of the reactor insert, so that coke formation in the apparatus is minimized.

10. The apparatus of claim 1 wherein the sleeve has an upper portion of diameter D1, and a lower portion of diameter D2 where D1 is greater than D2.

11. The apparatus of claim 10 wherein the external surface of the upper portion of the sleeve defines grooves which form fluid passages.

12. The apparatus of claim 1 wherein the reactor insert defines grooves which form fluid passages.

13. The apparatus of claim 1 wherein the reactor insert has an first section of diameter D4 near to the first end of the reactor insert, and a second section of diameter D3 near to the second end of the reactor insert where D3 is greater than D4.

14. The apparatus of claim 13 wherein the second section of the reactor insert defines grooves which form fluid passages.

15. The apparatus of claim 1 wherein said housing has a length, an internal surface and an external surface where material is removed to form grooves in the internal surface of said housing.

16. The apparatus of claim 1 wherein the open end of the housing contains a flange and the second end of the reactor insert contains a flange.

17. The apparatus of claim 1 wherein the housing, the sleeve, and the reactor insert are cylindrical.

18. The apparatus of claim 1 wherein said first and second seals are o-rings.

19. The apparatus of claim 1 wherein the top end of the sleeve is flared and defines notches.

20. The apparatus of claim 19 further comprising a projection within said housing to engage said top end of said sleeve.

21. The apparatus of claim 1 further comprising a reactant reservoir in fluid communication with said first fluid conduit.

22. The apparatus of claim 4 further comprising a sampling device in fluid communication with said additional fluid conduit.

23. The apparatus of claim 1 further comprising additional sets of elements a) through e) of claim 1 to form a plurality of reactors for conducting multiple simultaneous catalyst evaluations.

24. The apparatus of claim 23 further comprising a support unit supporting each of the housings.

25. The apparatus of claim 23 further comprising a second support unit supporting each of the reactor inserts.

26. The apparatus of claim 1 further comprising an effluent conduit in fluid communication with the closed end of the housing.

27. The apparatus of claim 26 further comprising a reactant reservoir in fluid communication with said fluid conduit and a sampling device in fluid communication with said effluent conduit.

28. The apparatus of claim 27 wherein the reactor insert further comprises an additional fluid conduit in fluid communication with a fluid reservoir.

29. An apparatus for conducting multiple simultaneous catalyst evaluations comprising:
a) a plurality of housings each having an open end and a closed end, each said housing supported by a first support;
b) a plurality of sleeves each having a top end, a bottom end, and a cross-section, said bottom ends each inserted within said open ends of said housings;
c) a plurality of fluid permeable structures attached to said sleeves and at least partially spanning the cross-section of said sleeves;
d) a plurality of reactor inserts supported by a second support, each reactor insert having a first end and a second end, the first ends inserted within the top ends of the sleeves defining a plurality of reaction chambers between the sleeves and the reactor inserts, the second ends each containing a first and a second fluid conduit, the reactor inserts further comprising first portions defining a volume of no fluid flow which forms said first ends and second portions adjacent said second ends defining volumes for fluid flow from the second fluid conduits to the reaction chambers and defining at least one introduction point of fluid into each reaction chamber where the introduction point is positioned to minimize stagnant fluid in the reaction chamber;
e) a plurality of first seals and a plurality of second seals, the first seals engaging the reactor inserts and said housings, and the second seals engaging the reactor inserts and said sleeves,
f) a plurality of thermowells capable of housing a temperature sensor said thermowells extending from the second ends of the inserts, through the second and first portions of the reactor inserts, beyond the first ends of the inserts, and into the reaction chambers
g) a plurality of temperature sensors housed within the thermowells; and
h) a heat source adjacent said housings.

30. The apparatus of claim 29 further comprising a plurality of effluent conduits in fluid communication with the closed ends of the housings.

31. A process for evaluating the performance of a catalyst comprising:
a) containing at least one catalyst in a reaction chamber of a reactor, the reactor having a reactor insert placed within a sleeve and inserted into a housing, said sleeve having a cross-section spanned by an attached fluid permeable structure, the reaction chamber of the reactor being defined by a seal engaging the reactor insert and the sleeve, the fluid permeable structure attached to the sleeve, and a first end of the corresponding reactor insert, said reactor insert comprising a first portion defining a volume of no fluid flow forming said first end of the reactor insert and a second portion defining a volume for fluid flow from a second fluid conduit to the reaction chamber and defining at least one introduction point of fluid into the reaction chamber where the introduction point is positioned near to a first seal engaging the reactor insert and the sleeve to minimize stagnant fluid in the reaction chamber;
b) flowing fluid reactant through a first conduit of the reactor and through the second portion of the reactor insert and introducing the fluid into the reaction chamber through the introduction point positioned near to the seal engaging the reactor insert and the sleeve;
c) contacting, in the reaction chamber, the fluid reactant with the catalyst contained in the reaction chamber to form an effluent;
d) flowing the effluent through the fluid permeable structure attached to the sleeve and into at least one channel formed by the interior surface of the housing and the external surface of the corresponding sleeve into a second fluid conduit to remove the effluent from the reactor; and
e) analyzing the effluent.

32. The process of claim 31 further comprising performing additional sets of steps a) through d) in parallel using a plurality of reactors to combinatorially evaluate the performance of a multiplicity of catalysts.

33. The process of claim 31 wherein the second fluid conduit is defined by the reactor insert.

34. The process of claim 31 wherein the second fluid conduit is defined by the housing and further comprising introducing a diluent fluid into the channel formed by the interior surface of the housing and the external surface of the corresponding sleeve to mix with the effluent from the reactor.

35. The process of claim 31 further comprising analyzing the effluent periodically over time.

36. The process of claim 31 further comprising sampling the effluent prior to analyzing the effluent.

37. The process of claim 32 further comprising simultaneously sampling the effluents prior to analyzing the effluents.

38. The process of claim 31 further comprising measuring the temperature in the reaction chamber.

39. A process for evaluating the performance of a catalyst comprising:
a) containing at least one catalyst in a reaction chamber of a reactor, the reactor having a reactor insert placed within a sleeve and inserted into a housing, said sleeve having a cross-section spanned by an attached fluid permeable structure, the reaction chamber of the reactor being defined by a seal engaging the reactor insert and the sleeve, the fluid permeable structure attached to the sleeve, and a first end of the corresponding reactor insert, said reactor insert comprising a first portion defining a volume of no fluid flow forming said first end of the reactor insert and a second portion defining a volume for fluid flow from a second fluid conduit to the reaction chamber and defining at least one introduction point of fluid into the reaction chamber where the introduction point is positioned near to a first seal engaging the reactor insert and the sleeve to minimize stagnant fluid in the reaction chamber;
b) flowing fluid reactant through a first conduit of the reactor and through at least one channel formed by the interior surface of the housing and the external surface of the sleeve, through the fluid permeable structure attached to the sleeve and into the reaction chamber;
c) contacting, in the reaction chamber, the fluid reactant with the catalyst contained in the reaction chamber to form an effluent;
d) flowing the effluent from the reaction chamber into the second portion of the reactor insert at a point positioned near to the first seal engaging the reactor insert and the sleeve;
e) flowing the effluent through the second portion of the reactor insert and into a second fluid conduit to remove the effluent from the reactor; and
f) analyzing the effluent.

40. The process of claim 39 further comprising performing additional sets of steps a) through e) in parallel using a plurality of reactors to combinatorially evaluate the performance of a multiplicity of catalysts.

41. The process of claim 39 further comprising analyzing the effluent periodically over time.

42. The process of claim 39 further comprising sampling the effluent prior to analyzing the effluent.

43. The process of claim 40 further comprising simultaneously sampling the effluents prior to analyzing the effluents.

44. The process of claim 39 further comprising measuring the temperature in the reaction chamber.

45. The process of claim 39 wherein the catalyst is in a fluidized bed mode.
